(19) United States
(12) Patent Application Publication
(10) Pub. No.: US 2011/0242077 A1
(43) Pub. Date: Oct. 6, 2011

(54) DISPLAY DEVICE AND PORTABLE TERMINAL

(76) Inventor: Nobuhiro Kuwabara, Osaka (JP)

(21) Appl. No.: 13/133,111

(22) PCT Filed: Sep. 16, 2009
(86) PCT No.: PCT/JP2009/066180

§ 371 Date: Jun. 6, 2011

(30) Foreign Application Priority Data
Jan. 16, 2009 (JP) 2009-007996

(51) Int. Cl. G09G 3/36; G09G 5/00

(52) U.S. Cl. 345/209; 345/96

(57) ABSTRACT

The present invention relates to an active matrix display device including a plurality of pixels and a source driver (23) which supplies image data (VIDEO), which has been externally supplied, to the plurality of pixels. Each of the plurality of pixels has: a data storing section (30) for storing the image data supplied from the source driver (23); a latch circuit (40) which latches, at a predetermined timing (LP signal), the image data which is stored in the data storing section (30); and a polarity reversing circuit (50) for reversing a polarity of the image data which is latched by the latch circuit (40). The image data, whose polarity is reversed by the polarity reversing circuit (50), is written into the each of the plurality of pixels. This makes it possible to improve a display quality by eliminating a difference of write time per pixel between frames.

### TECHNICAL FIELD

The present invention relates to a timing signal which is used when a display device carries out a display.

### BACKGROUND ART

According to a known display device, a memory circuit (hereinafter, referred to as pixel memory) is provided for each pixel, and it is possible to display, at low power consumption, an image (a still image) without image data being externally supplied continuously, by causing image data to be stored (held) in the pixel memory. The following reductions contribute to the low power consumption: (i) since it is not necessary, after image data is once written into a pixel, for image data to charge/discharge a data signal line via which the image data is supplied to the pixel, power consumption caused by the charging/discharging can be reduced; and (ii) since it is not necessary, after image data is once written into a pixel, to transmit image data from outside of a panel to a driver, power consumption caused by the transmission can be reduced.

An SRAM pixel memory and a DRAM pixel memory have been developed as the pixel memory. Since the display device employs a digital image voltage, (i) a crosstalk hardly occurs and (ii) an excellent display quality can be secured.

FIG. 17 illustrates a configuration of a display device disclosed in Patent Literature 1, which exemplifies the above described display device including such a pixel memory.

The display device disclosed in Patent Literature 1 mainly includes a word line controlling circuit 8, a bit line controlling circuit 9, RAMs each serving as gradation data storing means, and ON/OFF waveform selecting circuits 13. Each of the RAMs includes (i) field-effect transistors (FET) 5 and 7 each of which serves as a switching element and (ii) a memory section 6. Each of word lines W1, W2, . . . , and Wn of the word line controlling circuit 8 is connected with gate terminals (control electrodes) of corresponding ones of the FETs 5 and 7. Moreover, the FETs 5 and 7 have respective conduction electrodes whose one ends are connected with respective data lines D11 and D11′ of the bit line controlling circuit 9. The memory sections 6 have respective output terminals OUT which are connected with respective pixel electrodes 10a through 10d via a corresponding one of the ON/OFF waveform selecting circuits 13.

The following describes how the memory section 6 of the display device operates, with reference to FIG. 18 which illustrates a configuration of the memory section 6. In a case where data having a high-level electric potential is written into a node Q of a memory cell 6a, the bit line controlling circuit 9 first causes (i) the data line D11 to have a high-level electric potential and (ii) the data line D11′ to have a low-level electric potential. When the word line controlling circuit 8 causes the word line W1 to have a high-level electric potential, the FETs 5 and 7 turn on. This causes the node Q on an FET 5 side of the memory cell 6a to have a high-level electric potential, whereas a node Q′ on an FET 7 side to have a low-level electric potential (see FIG. 18). This secures and maintains a stable state, and writing of data can be thus carried out.

After the writing of the data is carried out, states of the node Q and the node Q′ in the memory cell 6a are not changed (are maintained), even when the FETs 5 and 7 turn off in response to a change in the electric potential of the word line W1 into a low-level electric potential.

Therefore, the output terminal OUT of the memory section 6 has a high-level electric potential because the electric potential of the node Q′ is reversed by an inverter 6d, and then the data having the high-level electric potential, which data has been written into the data line D11 at the beginning, is supplied to the ON/OFF waveform selecting circuit 13.

In a case where data having a low-level electric potential is written into the memory cell 6a, (i) the bit line controlling circuit 9 causes (a) the data line D11 to have a low-level electric potential and (b) the data line D11′ to have a high-level electric potential and (ii) the word line controlling circuit 8 causes the word line W1 to have a high-level electric potential, so that the FETs 5 and 7 turn on. This causes the node Q on the FET 5 side of the memory cell 6a to have a low-level electric potential, whereas the node Q′ on the FET 7 side to have a high-level electric potential. This secures and maintains a stable state, and writing of data can be thus carried out.

Therefore, the output terminal OUT of the memory section 6 has a low-level electric potential because the electric potential of the node Q′ is reversed by the inverter 6d, and then the data having the low-level electric potential, which data has been written into the data line D11 at the beginning, is supplied to the ON/OFF waveform selecting circuit 13.

This is how data can be written into each of the RAMs. The data, stored in the RAMs, allows a display state to be maintained.

### CITATION LIST

### Patent Literature

Patent Literature 1
Japanese Patent Application Publication, Tokukaihei, No. 11-326874 (Publication Date: Nov. 26, 1999)

### SUMMARY OF INVENTION

### Technical Problem

However, the conventional display device has a problem that a display quality is deteriorated. This is because write time in a frame in which image data is written into a pixel is different from that in a following frame in which a polarity is reversed. Such a problem is not inherent in the display device including the pixel memory, and therefore occurs also in a conventional active matrix display device to which image data is continuously and externally supplied. Such a problem, in particular, notably occurs in a display device, including pixel memories, which is suitable for a still image display (such as a standby screen of a mobile phone) and which is required to achieve low power consumption. This will be described below with a concrete example.

FIG. 19 is a timing chart illustrating an example of how the display device operates. In FIG. 19, (i) TCOM indicates a voltage of a counter electrode and (ii) a pixel A and a pixel B show (a) signal electric potentials to be written into the respective pixels and (b) display states of the respective pixels. Moreover, this concrete example is assumed to (i) employ a frame-reversal driving which is employed by the display device including pixel memories and (ii) an attention is mainly focused on a certain frame (first frame: F1) and a following frame (second frame) out of consecutive frames. Note that image data (VIDEO DATA) corresponds to one (1) word line shown in FIG. 17. In the first frame (F1), the image data (VIDEO DATA) is made up of pieces of display data of a pixel A (black) and a pixel B (white). In the second frame (F2), no new display data is supplied.

When black display data is newly supplied, in the first frame, to the pixel A which is carrying out a white display, a signal electric potential of the pixel A is changed at that time so that the white display is changed to a black display. The pixel A maintains the black display data until next display data is supplied. In the second frame, a polarity of a voltage of the black display data is reversed in sync with a polarity reversal of the TCOM.

When white display data is newly supplied, in the first frame, to the pixel B which is carrying out a black display, a signal electric potential of the pixel B is changed at that time so that the black display is changed to a white display. The pixel B maintains the white display data until next display data is supplied. In the second frame, a polarity of a voltage of the white display data is reversed in sync with a polarity reversal of the TCOM.

According to the conventional display device, a signal electric potential is written into a pixel in sync with a switching of display data. This causes a problem that the time, required for writing image data into the pixel, differs from frame to frame. In a case of, for example, a normally black display and in a case where, in the pixel A, white display data having negative polarity is switched to black display data having a positive polarity in the first frame, time (ta1) during which the black display data having the positive polarity is being applied to the pixel A in the first frame is different from time (ta2) during which the black display data having the negative polarity is being applied to the pixel A in the second frame (i.e., ta1<ta2) (see the lowest two waveforms of FIG. 19). Moreover, in a case where, in the pixel B, black display data having positive polarity is switched to white display data having a negative polarity in the first frame, time (tb1) during which the white display data having the negative polarity is being applied to the pixel B in the first frame is different from time (tb2) during which the white display data having the positive polarity is being applied to the pixel B in the second frame (i.e., tb1<tb2).

Therefore, in a case where images having an identical tone are displayed in consecutive frames, the image to be displayed differs from frame to frame. This causes a deterioration in display quality.

The present invention is accomplished in view of the conventional problem, and its object is to provide a display device which can improve a display quality by preventing the write time from differing from frame to frame.

### Solution to Problem

In order to attain the object, a display device of the present invention includes: a plurality of pixels; and a display driver which supplies image data, which has been externally supplied, to the plurality of pixels, each of the plurality of pixels having: a data storing means for storing the image data supplied from the display driver; a latch circuit which latches, at a predetermined timing, the image data which is stored in the data storing means; and a polarity controlling means for controlling a polarity of the image data which is latched by the latch circuit, the image data, whose polarity is controlled by the polarity controlling means, being written into the each of the plurality of pixels.

According to the configuration, the image data stored in the data storing means is latched by the latch circuit at the predetermined timing, and then the polarity of the image data is reversed by the polarity controlling means. Then, the image data whose polarity has been reversed is written into the each of the plurality of pixels. That is, the image data is written into the each of the plurality of pixels at the predetermined timing, regardless of timing at which the image data is externally supplied to the display driver.

Therefore, for example, in a case where image data, stored in the data storing means, is latched in sync with a polarity reversal of a voltage of a counter electrode in a frame inversion driving, the image data is to be written into a pixel in sync with a switching of frames. This allows prevention of the time, required for writing image data into a pixel, from differing from frame to frame. Therefore, in a case where identical images are displayed in consecutive frames, it is possible to prevent the image to be displayed from differing from frame to frame. As such, a display quality can be improved.

According to the display device, it is possible that the latch circuit latches the image data, which is stored in the data storing means, in sync with a polarity reversal of a voltage of a counter electrode.

According to the display device, it is possible that the polarity controlling means reverses, in each frame, the polarity of the image data which is latched by the latch circuit.

According to the display device, it is possible that the display driver includes a timing generator to which image data and a timing signal are externally supplied, a data signal line driving circuit which drives a plurality of data signal lines in response to outputs of the timing generator, and a scanning signal line driving circuit which sequentially drives a plurality of scanning signal lines in response to outputs of the timing generator; and the data storing means is provided, at an intersection of a corresponding one of the plurality of data signal lines and a corresponding one of the plurality of scanning signal lines, so as to be connected with the corresponding one of the plurality of data signal lines and the corresponding one of the plurality of scanning signal lines.

According to the display device, it is possible that the display driver includes an address decoder which specifies a pixel to which image data is supplied, and a data driver which supplies the image data to the pixel, the plurality of pixels being provided at respective intersections of a plurality of address signal lines which extend in a row direction and a column direction and are driven by the address decoder, and the data storing means being connected with, at a corresponding one of the intersections, a corresponding one of the plurality of address signal lines and a corresponding one of a plurality of data signal lines which are driven by the data driver.

According to the configuration, data is written into only the specified pixel in a frame. It is therefore not necessary to write data into all the pixels in each frame. This brings about an effect of reducing power consumption.

According to the display device, it is possible that the display driver and a display panel are provided monolithically.

According to the configuration, the display driver and the display panel can be provided monolithically. This makes it possible to reduce a size of the display device and to simplify production processes.

It is preferable that the display device is a liquid crystal display device.

In order to attain the object, a portable terminal of the present invention includes the display device as a display.

According to the configuration, it is possible to meet the demand for providing a portable terminal with low power consumption.

### Advantageous Effects of Invention

As described above, the display device of the present invention includes the latch circuit which latches, at predetermined timing, image data stored in the data storing means.

This makes it possible to provide a display device which can improve a display quality by eliminating a difference of write time per pixel between frames.

### BRIEF DESCRIPTION OF DRAWINGS

FIG. 1 is a block diagram schematically illustrating a configuration of a display panel of Embodiment 1.

FIG. 2 is a block diagram schematically illustrating a configuration of a liquid crystal display device of Embodiment 1.

FIG. 3 is a circuit diagram illustrating a configuration of a data storing section shown in FIG. 1.

FIG. 4 is a circuit diagram illustrating a configuration of a latch circuit shown in FIG. 1.

FIG. 5 is a circuit diagram illustrating a configuration of an LP signal generating circuit shown in FIG. 1.

FIG. 6 is a circuit diagram illustrating a configuration of a polarity reversing circuit shown in FIG. 1.

FIG. 7 is a timing chart illustrating an example of operations in a liquid crystal display device of Embodiment 1.

FIG. 8 is a circuit diagram illustrating another configuration of the data storing section shown in FIG. 3.

FIG. 9 is a circuit diagram illustrating another configuration of the data storing section shown in FIG. 3.

FIG. 10 is a circuit diagram illustrating another configuration of the LP signal generating circuit shown in FIG. 5.

FIG. 11 is a block diagram schematically illustrating a configuration of a liquid crystal display device of Embodiment 2.

FIG. 12 is a circuit diagram illustrating a connection relation between an address decoder and a data storing section in the liquid crystal display device shown in FIG. 11.

FIG. 13 is a timing chart illustrating an example of operations in the liquid crystal display device of Embodiment 2.

FIG. 14 is a block diagram schematically illustrating a configuration of a liquid crystal display device of Embodiment 3.

FIG. 15 is a circuit diagram illustrating a configuration of the data storing section shown in FIG. 14.

FIG. 16 is a timing chart illustrating an example of operations in the liquid crystal display device of Embodiment 3.

FIG. 17 is a block diagram schematically illustrating a configuration of a conventional liquid crystal display device.

FIG. 18 is a circuit diagram illustrating a configuration of a memory of the liquid crystal display device shown in FIG. 17.

FIG. 19 is a timing chart illustrating an example of operations in the liquid crystal display device shown in FIG. 17.

### DESCRIPTION OF EMBODIMENTS

### Embodiment 1

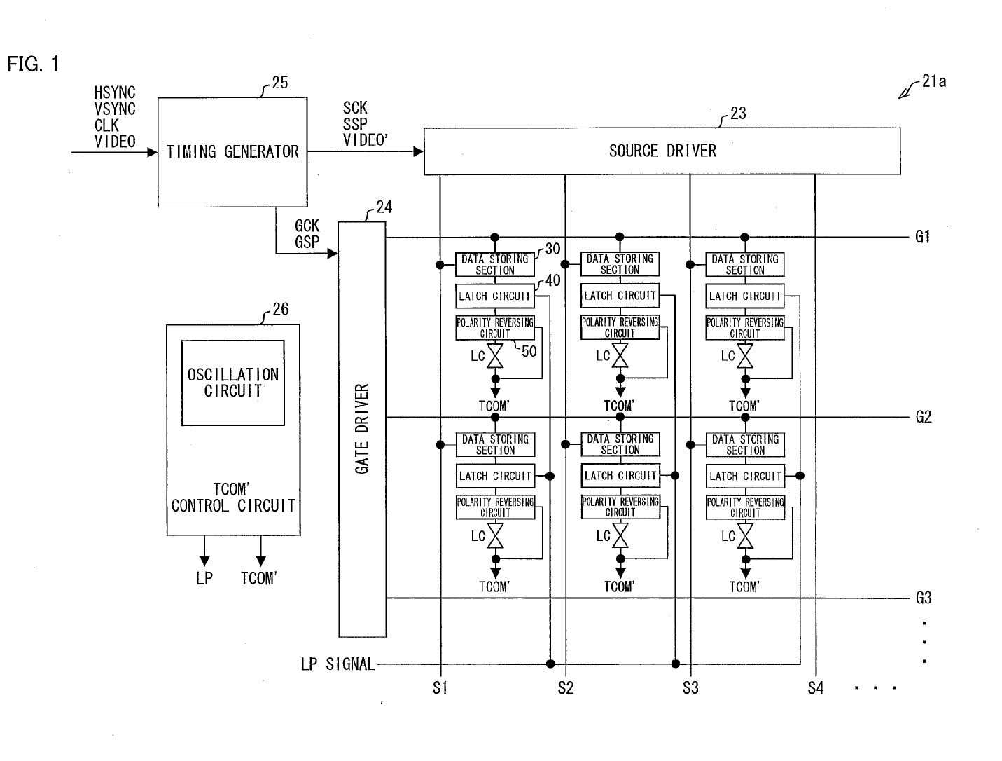

The following describes Embodiment 1 of the present invention with reference to FIGS. 1 through 10.

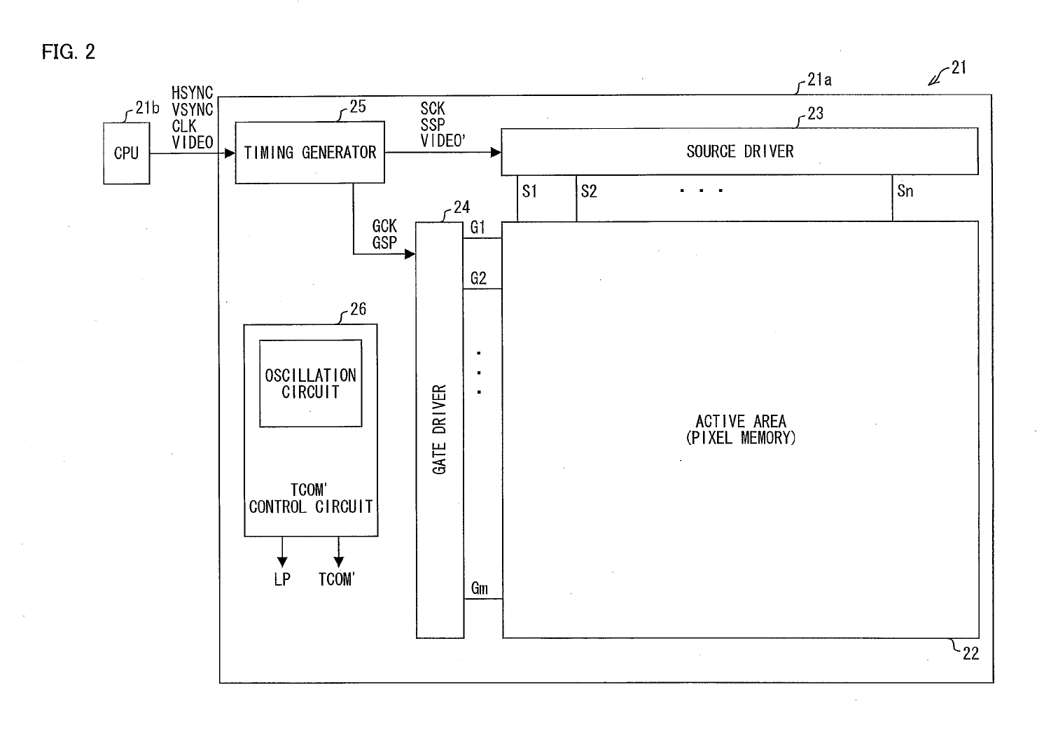

FIG. 2 schematically illustrates a configuration of a liquid crystal display device (display device) 21 of the present Embodiment 1.

The liquid crystal display device 21 is a display device which is included in a portable terminal such as a mobile phone. The liquid crystal display device 21 includes a display panel 21a and a CPU 21b. In the display panel 21a, various circuits are monolithically provided. The CPU 21b controls how the liquid crystal display device 21 carries out a display. Various timing signals and image data are supplied, under the control of the CPU 21b, to the display panel 21a.

The display panel 21a has (i) an active area 22, (ii) a source driver (data signal line driving circuit) 23 which drives source lines (data signal lines) S1, S2, . . . , and Sn, (iii) a gate driver (scanning signal line driving circuit) 24 which drives gate lines (scanning signal lines) G1, G2, . . . , and Gm, (iv) a timing generator 25, and (v) a TCOM′ control circuit 26. Note that the source driver 23, the gate driver 24, and the timing generator 25 constitute a display driver.

In the active area 22, pixels, each having colors of R, G, and B, are provided in a matrix manner, and each of the pixels has a pixel memory. The source driver 23 is a driver circuit which supplies image data to the active area 22 via the source lines S1, S2, . . . , and Sn. The source driver 23 includes a shift register (not illustrated) and a data latch circuit (not illustrated). The gate driver 24 selects pixels to which the image data is supplied, via the gate lines G1, G2, . . . , and Gm. The timing generator 25 generates, based on signals which are supplied under the control of the CPU, various signals which are to be supplied to the source driver 23 and the gate driver 24.

The following describes a configuration of pixels PIX provided in the active area 22, with reference to FIG. 1. FIG. 1 is a block diagram schematically illustrating a configuration of the display panel 21a in accordance with Embodiment 1.

Each of the pixels PIX has (i) a data storing section (data storing means) 30, (ii) a latch circuit 40, (iii) a polarity reversing circuit (polarity controlling means) 50, (iv) liquid crystal LC, and (v) a pixel electrode (not illustrated).

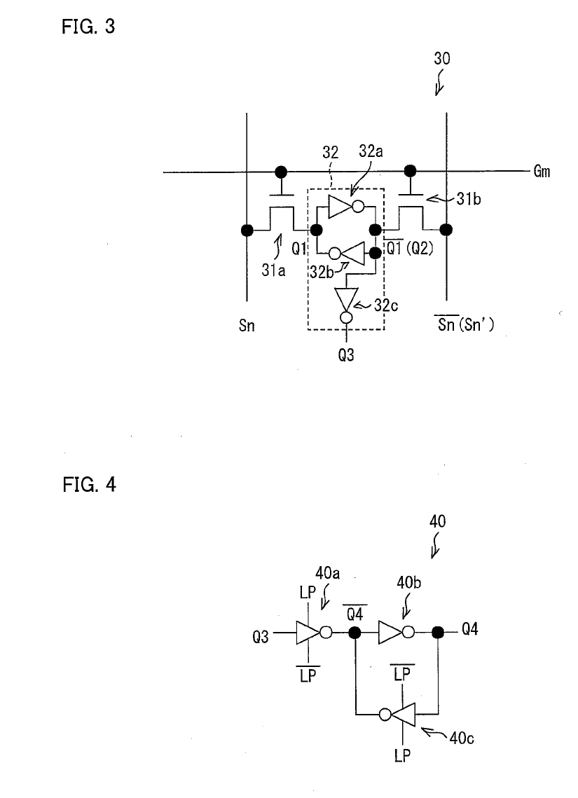

The data storing section 30 is made up of (i) a field-effect transistors (FET) 31a and 31b which serve as switching elements and (ii) a memory section 32 (see FIG. 3). The data storing section 30 serves as a random access memory (RAM). Note that the data storing section 30 shown in FIG. 3 is exemplified by a 1-bit memory element. However, the present embodiment is not limited to this, and the data storing section 30 can therefore be a multi-bit memory element. The memory section 32 includes inverters 32a and 32b by which a flip-flop is configured, and further includes an inverter 32c which reverses logic of data held by the flip-flop.

The FET 31a has (i) a control electrode which is connected with the gate line Gm, (ii) a first conduction electrode which is connected with the source line Sn, and (iii) a second conduction electrode which is connected with a node Q1 of the memory section 32. The FET 31b has (i) a control electrode which is connected with the gate line Gm, (ii) a first conduction electrode which is connected with a source line Sn′ (complementary data signal line of Sn; not illustrated in FIG. 1), and (iii) a second conduction electrode which is connected with a node Q2 of the memory section 32. The data storing section 30 is connected with the latch circuit 40 via the inverter 32c of the memory section 32.

The latch circuit 40 is made up of three inverters 40a, 40b, and 40c, and is connected with an output terminal of the inverter 32c of the memory section 32 via a node Q3 (see FIG. 4). The latch circuit 40 (i) latches, in sync with switching of High/Low of an LP signal, data supplied from the memory section 32 of the data storing section 30 and then (ii) supplies the data to the polarity reversing circuit 50. Note that the node Q3 of the latch circuit 40 shown in FIG. 4 can be connected with the node Q1 of the data storing section 30, instead of the output terminal of the inverter 32c. In such a configuration, the transistor 31b can be omitted.

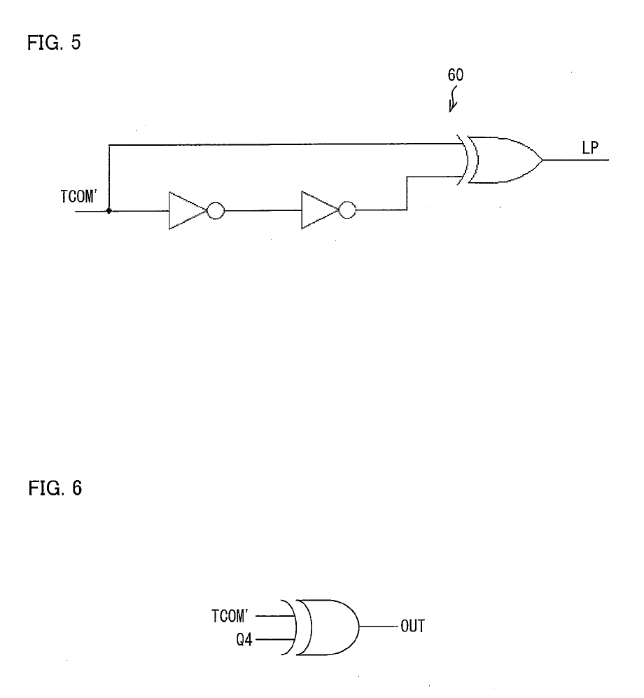

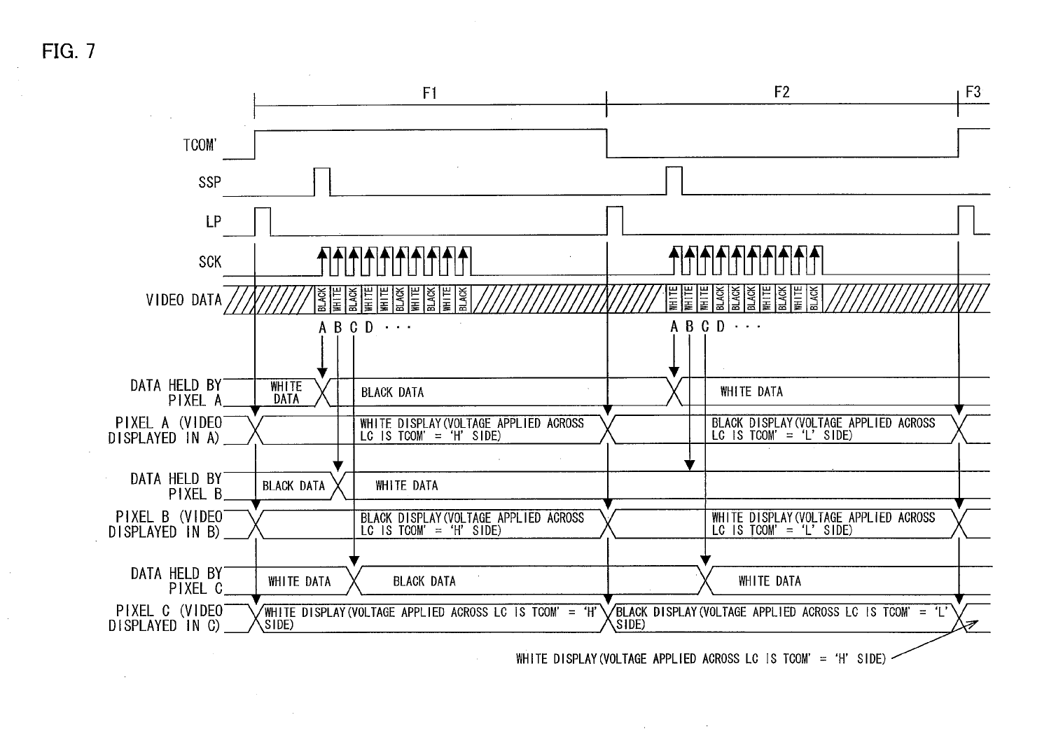

The LP signal is generated, for example, by an LP signal generating circuit 60 which includes two inverters (NOT circuits) and an XOR circuit (see FIG. 5). Specifically, the LP signal generating circuit 60 generates the LP signal in response to a TCOM′ signal which is a voltage of a counter electrode (not illustrated) (later described with reference to FIG. 7). More specifically, the TCOM′ signal is supplied to one of terminals of the XOR circuit of the LP signal generating circuit 60, and a TCOM′ signal, which has been delayed by the two cascaded inverters, is supplied to the other of the terminals of the XOR circuit. This causes a signal to be outputted from the LP signal generating circuit 60, which signal has a pulse width corresponding to delayed time by which the TCOM′ signal has been delayed by the two cascaded inverters. The number of the cascaded inverters shown in FIG. 5 is two but the present embodiment is not limited to this, provided that the number is any even number. The LP signal generating circuit 60 is provided in the TCOM′ control circuit 26. The TCOM′ control circuit 26 includes an oscillation circuit. Note that the TCOM′ control circuit 26 can be provided outside of the display panel 21a.

The polarity reversing circuit 50 is made up of an XOR circuit (see FIG. 6), and a TCOM′ signal and data supplied from the latch circuit 40 are supplied to the polarity reversing circuit 50. The polarity reversing circuit 50 reverses a polarity of the data thus supplied from the latch circuit 40, and then the data, whose polarity has been reversed, is supplied to the pixel electrode.

The liquid crystal LC is light dispersion liquid crystal such as polymer-dispersed liquid crystal (PDLC) or polymer-network liquid crystal (PNLC). The liquid crystal LC is provided between the pixel electrode and the counter electrode. A voltage, which is an electric potential difference between (i) the data supplied from the polarity reversing circuit 50 to the pixel electrode and (ii) the TCOM′ signal which is a voltage of the counter electrode, is applied across the liquid crystal LC. This causes a corresponding pixel PIX to be in a desired display state.

The following describes an example of how the liquid crystal display device 21 having the above configuration operates, with reference to a timing chart shown in FIG. 7.

Upon receipt, from the CPU, of a horizontal sync signal HSYNC, a vertical sync signal VSYNC, a clock CLK, and image data VIDEO, the timing generator 25 of the liquid crystal display device 21 (see FIG. 2) generates (i) a source clock SCK, a source start pulse SSP, and image data VIDEO′ which are to be supplied to the source driver 23 and (ii) a gate clock GCK and a gate start pulse GSP which are to be supplied to the gate driver 24 (see FIG. 2). The source driver 23 supplies image data to the source lines S1, S2, . . . , and Sn, via processes made by the shift register and the data latch circuits in the source driver 23. The gate driver 24 sequentially supplies gate signals, via processes made by shift registers in the gate driver 24, to the gate lines G1, G2, . . . , and Gm.

In FIG. 7, (i) “TCOM′” indicates a signal electric potential of a counter electrode (not illustrated), (ii) “LP” indicates a timing signal generated by the LP signal generating circuit 60, (iii) “SCK” indicates a clock signal supplied to the source driver 23, and (iv) “pixel A”, “pixel B”, and “pixel C” indicate (a) respective signal electric potentials which are written into the pixels A, B, and C, and (b) respective display states of the pixels A, B, and C. According to the present embodiment, a frame-reversal driving is employed, and an attention is mainly focused on a certain frame (first frame: F1) and a following frame (second frame) out of consecutive frames. Note that, (i) in the first frame (F1), part of image data (VIDEO DATA) is made up of pieces of display data for the pixel A (black), the pixel B (white), and the pixel C (black) and (ii) in the second frame (F2), part of the image data is made up of pieces of display data for the pixel A (white), the pixel B (white), and the pixel C (white).

With regard to the pixel A, black display data is supplied to the data storing section 30 in sync with a rising edge of the source clock SCK, in a state where white display data has been written in a frame (a followed frame) which is followed by the first frame (i.e., in a state where white display data is stored in the data storing section 30). The black display data thus supplied to the data storing section 30 is held by the memory section 32 until another display data is supplied to the data storing section 30. The black display data held by the memory section 32 is supplied to the latch circuit 40 (see FIG. 1). In the latch circuit 40, the black display data is latched in sync with a rising edge of the LP signal, and is then supplied to the polarity reversing circuit 50 (see FIG. 1). In the polarity reversing circuit 50, the black display data is latched at timing at which the second frame starts, that is, at timing at which a polarity of the TCOM′ signal is reversed. Then, a voltage polarity of the black display data is reversed in the polarity reversing circuit 50, and is then supplied to the pixel electrode. Accordingly, a voltage, which is an electric potential difference between (i) the black display data whose polarity is reversed and (ii) the TCOM′ signal, is applied across the liquid crystal LC. This causes the pixel A to be switched from the white display to a black display in the second frame.

Subsequently, in the pixel A, white display data is supplied to the data storing section 30 in sync with a rising edge of the source clock SCK, in a state where the black display data has been written in the second frame (i.e., in a state where the black display data is stored in the data storing section 30). In the data storing section 30, the white display data is held by the memory section until another display data is supplied to the data storing section 30. The white display data held by the memory section 32 is supplied to the latch circuit 40. In the latch circuit 40, the white display data is latched in sync with a rising edge of the LP signal, and is then supplied to the polarity reversing circuit 50. In the polarity reversing circuit 50, the white display data is latched at timing at which a third frame (F3) starts, that is, at timing at which a polarity of the TCOM′ signal is reversed. Then, a voltage polarity of the white display data is reversed in the polarity reversing circuit 50, and is then supplied to the pixel electrode. Accordingly, a voltage, which is an electric potential difference between (i) the white display data whose polarity is reversed and (ii) the TCOM′ signal, is applied across the liquid crystal LC. This causes the pixel A to be switched from the black display to a white display in the third frame.

In a case where new black display data serving as image data is supplied to the pixel A in the first frame, the new black display data is not written into the pixel A at this timing but white display data of the followed frame is still written into the pixel A. The new black display data is written into the pixel A at timing at which a polarity of a subsequent TCOM′ signal is reversed. That is, even if display data is supplied to the liquid crystal display device 21 at any timing during one (1) frame period, then such display data is to be written into a pixel at timing at which a polarity of the TCOM′ signal is reversed. This allows each frame (here, F1 and F2) to have identical write time during which display data is being written into a pixel.

For example, in a case of a normally black display, (i) white display data having a negative polarity is written into a pixel A in a first frame, (ii) black display data having a positive polarity is written into the pixel A in a second frame, and (iii) white display data having a negative polarity is written into the pixel A in a third frame. Note that each of the pieces of display data (white (negative)→black (positive)→white (negative)) is being written into the pixel A for identical period of time.

With regard to the pixel B, white display data is supplied to the data storing section 30 in sync with a rising edge of the source clock SCK, in a state where black display data has been written in a frame (a followed frame) which is followed by the first frame (i.e., in a state where the black display data is stored in the data storing section 30). The white display data thus supplied to the data storing section 30 is held by the memory section 32 until another display data is supplied to the data storing section 30. The white display data held by the memory section 32 is supplied to the latch circuit 40 (see FIG. 1). In the latch circuit 40, the white display data is latched in sync with a rising edge of the LP signal, and is then supplied to the polarity reversing circuit 50 (see FIG. 1). In the polarity reversing circuit 50, the white display data is latched at timing at which the second frame starts, that is, at timing at which a polarity of the TCOM′ signal is reversed. Then, a voltage polarity of the white display data is reversed in the polarity reversing circuit 50, and is then supplied to the pixel electrode. Accordingly, a voltage, which is an electric potential difference between (i) the white display data whose polarity is reversed and (ii) the TCOM′ signal, is applied across the liquid crystal LC. This causes the pixel B to be switched from the black display to a white display in the second frame.

Subsequently, in the second frame, since image data to be displayed is white display data, the white display data is held by the data storing section 30, as with the first frame. Note that the white display data is supplied to the data storing section 30 (here, overwriting of the white display data) in the second frame. However, the display data is identical to that held in the first frame, and therefore the content itself in the data storing section 30 does not change. The white display data held by the data storing section 30 is supplied to the latch circuit 40. In the latch circuit 40, the white display data is latched in sync with a rising edge of the LP signal, and is then supplied to the polarity reversing circuit 50. In the polarity reversing circuit 50, the white display data is latched at timing at which the third frame (F3) starts, that is, at timing at which the polarity of the TCOM′ signal is reversed. Then, a voltage polarity of the white display data is reversed in the polarity reversing circuit 50, and is then supplied to the pixel electrode. Accordingly, a voltage, which is an electric potential difference between (i) the white display data whose polarity is reversed and (ii) the TCOM′ signal, is applied across the liquid crystal LC. This causes the white display to be held by the pixel B in the third frame.

In a case where new white display data which serves as image data is supplied to the pixel B in the first frame, the new white display data is not written into the pixel B at this timing but black display data of the followed frame is still written into the pixel B. The new white display data is written into the pixel B at timing at which a polarity of a subsequent TCOM′ signal is reversed.

For example, in a case of a normally black display, (i) black display data having a positive polarity is written into a pixel B in a first frame, (ii) white display data having a negative polarity is written into the pixel B in a second frame, and (iii) white display data having a positive polarity is written into the pixel B in a third frame. Note that each of the pieces of display data (black (positive)→white (negative)→white (positive)) is being written into the pixel B for identical period of time.

According to the operations of the liquid crystal display device 21 of Embodiment 1, no DC component is applied across the liquid crystal. This makes it possible to improve a display quality, as compared to conventional liquid crystal display devices.

Note that operations in the pixel C are basically identical to those in the pixel A, except that display data is supplied to the data storing section 30 of the pixel C at different timing. That is, it is possible to prevent the time, required for writing display data into a pixel, from differing from frame to frame. This makes it possible to uniformize a display quality of each pixel.

According to the operations, timing at which data is written into a pixel can be adjusted based on the LP signal. This allows the TCOM′ signal and the image data signal to be asynchronous. It is therefore not necessary to prepare a configuration in which a TCOM signal is supplied from the timing generator, unlike the conventional configuration. This allows an outputting circuit (the TCOM′ control circuit of the present embodiment) of the TCOM signal to be provided, separately from the timing generator 25, inside or outside of the liquid crystal display device 21. This makes it possible to (i) simplify the configuration of the timing generator 25 and (ii) cause the timing generator 25 to be commonly used in liquid crystal panels having respective different sizes.

Note that the timing chart of FIG. 7 shows an example configuration in which data is written into a pixel in each frame (F1, F2). However, the present embodiment is not limited to this. Specifically, the liquid crystal display device 21 of Embodiment 1 can also be exemplified by a configuration in which data is written into a pixel only in a required frame. This is because display data, which is once supplied to the data storing section 30, is held until new display data is supplied to the data storing section 30.

Note that the data storing section 30 and the LP signal generating circuit 60 which are employed in the liquid crystal display device 21 of Embodiment 1 are not limited to those shown in respective of FIGS. 3 and 5, and can therefore be configured as described below.

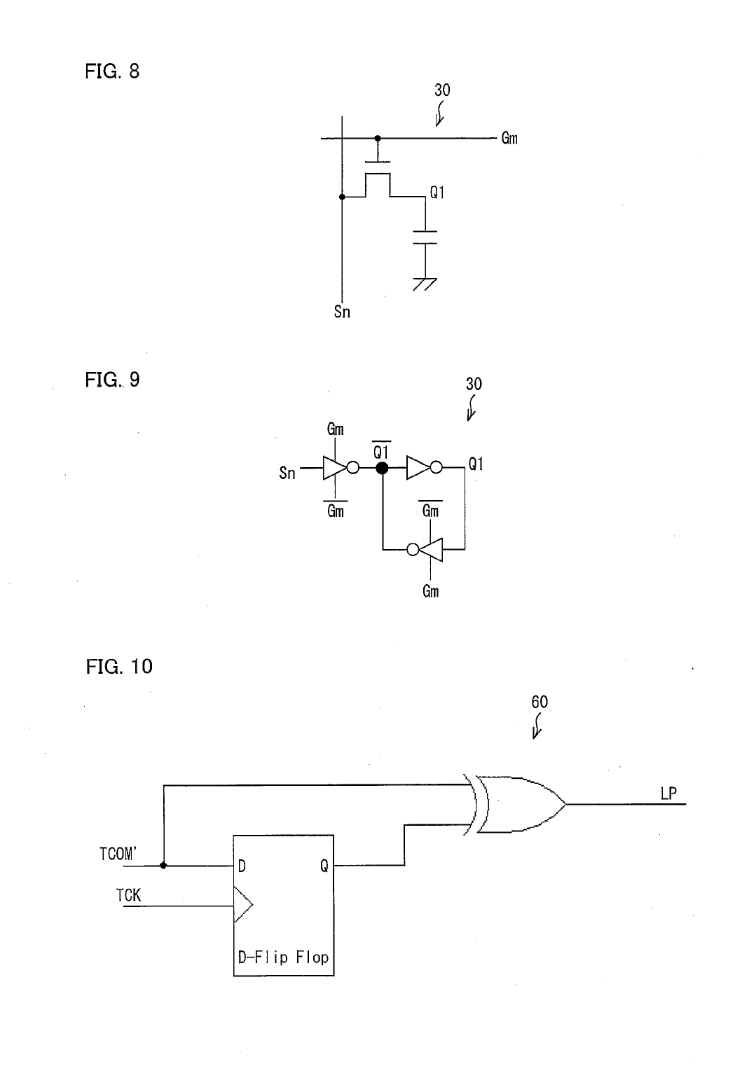

FIG. 8 is a circuit diagram illustrating a configuration of another data storing section 30. The data storing section 30 can be made up of a single transistor and a single capacitor (see FIG. 8). According to the data storing section 30, the capacitor is charged by an image data signal which is supplied via the source line Sn when the gate line Gm is selected. However, it is necessary to overwrite the image data signal at certain time intervals because the capacitor is gradually discharged due to leakage current of the transistor. Therefore, the configuration shown in FIG. 8 is particularly effective in a case where overwriting is frequently carried out.

FIG. 9 is a circuit diagram illustrating a configuration of a further data storing section 30. The data storing section 30 can be made up of three inverters (see FIG. 9). The data storing section 30 has a general latch circuit configuration. In a case where the gate line Gm is selected, data, which has been supplied via the source line Sn, is written into /Q1 (inverted Q1) via a first inverter in the data storing section 30. In a case where the gate line Gm is not selected, data is supplied from Q1 and then written into the /Q1 via an inverter circuit, so that the image data is maintained.

Note that, in a case where the data storing section 30 shown in FIG. 8 or 9 is applied to the liquid crystal display device 21, the node Q1 of the data storing section 30 can be connected with the node Q3 of a following latch circuit 40 (see FIG. 4).

FIG. 10 is a circuit diagram illustrating a configuration of another LP signal generating circuit 60. The LP signal generating circuit 60 can be made up of a D-flip-flop circuit and an XOR circuit (see FIG. 10). A TCK signal, which is generated by an oscillation circuit in a TCOM′ control circuit and serves as a clock signal, is supplied to the D-flip-flop circuit of the LP signal generating circuit 60. A TCOM′ signal is shifted by one (1) clock of the TCK signal, and is then supplied to the XOR circuit together with the TCOM′ signal. This causes a pulse signal to be generated from the LP signal generating circuit 60.

### Embodiment 2

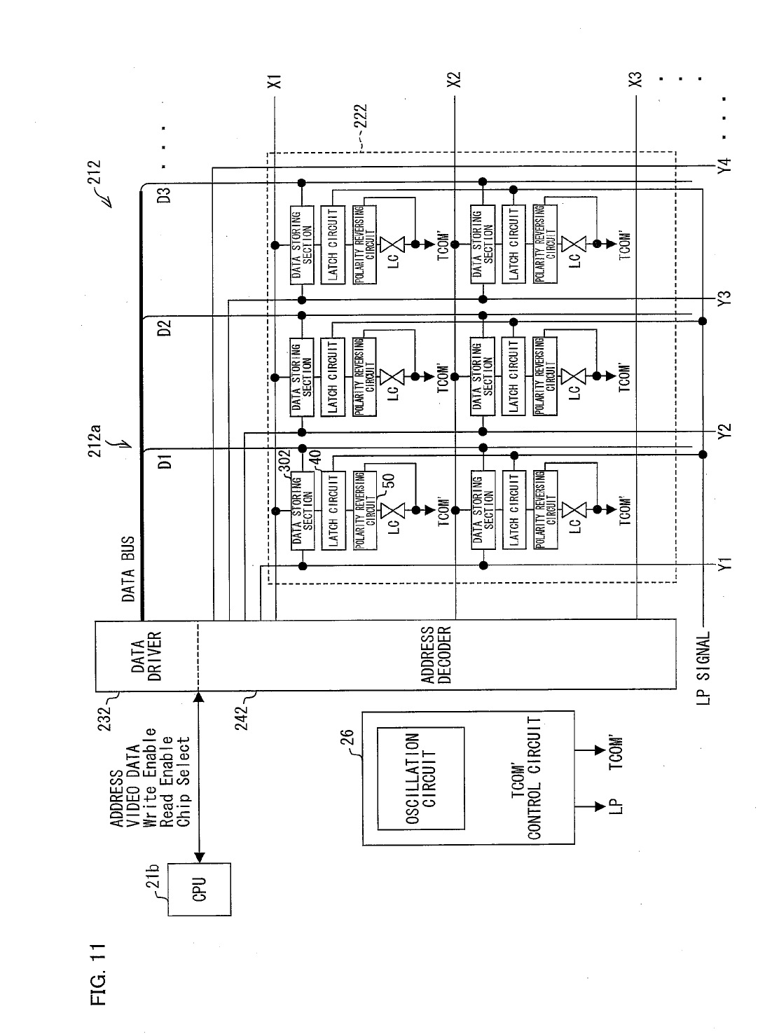

The following describes Embodiment 2 of the present invention with reference to FIGS. 11 through 13. The following mainly describes differences between a liquid crystal display device 212 of Embodiment 2 and the liquid crystal display device 21 of Embodiment 1. Note that, for convenience, the same reference numerals are given to members having functions identical to those shown in Embodiment 1, and descriptions as to such members are omitted here. Moreover, the terms, which are defined in Embodiment 1, are used in the same meanings also in the present embodiment, unless otherwise noted.

FIG. 11 illustrates a configuration of the liquid crystal display device (display device) 212 of Embodiment 2. The liquid crystal display device 212 includes a display panel 212a and a CPU 21b.

The display panel 212a has (i) an active area 222, (ii) a data driver 232, (iii) an address decoder 242, and (iv) a TCOM′ control circuit 26. The data driver 232 and the address decoder 242 constitute a display driver.

In the active area 222, pixels, each having colors of R, G, and B, are provided in a matrix manner, and each of the pixels has a pixel memory. The data driver 232 is a driver circuit which supplies image data to the active area 222 via data bus lines D1, D2, . . . . The address decoder 242 selects, based on an address signal (ADDRESS) supplied under the control of CPU, a pixel to be supplied with the image data. Specifically, the address decoder 242 selects, based on corresponding address signals X and Y, each of pixels provided at respective intersections of (i) address signal lines X1, X2, . . . which extend in the row direction and (ii) address signal lines Y1, Y2, . . . which extend in the column direction.

The following describes a configuration of each of pixels PIX provided in the active area 222, with reference to FIG. 11.

Each of the pixels PIX has (i) a data storing section 302, (ii) a latch circuit 40, (iii) a polarity reversing circuit 50, (iv) liquid crystal LC, and (v) a pixel electrode (not illustrated), as with Embodiment 1.

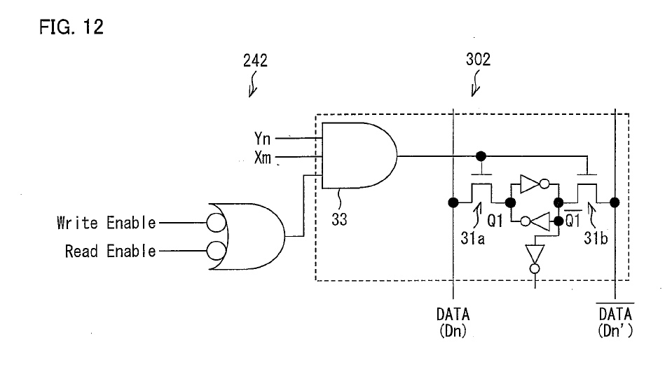

FIG. 12 is a circuit diagram illustrating how the address decoder 242 is connected with the data storing section 302. The data storing section 302 includes an AND circuit 33 (see FIG. 12) which causes FETs 31a and 31b, which constitute the data storing section 302, to turn on/off in response to signals X and Y supplied from the address decoder 242. The address decoder 242 supplies, to the data storing section 302 based on address signals (ADDRESS) supplied under the control of the CPU, (i) a signal (Xm) for specifying a row direction and (ii) a signal (Yn) for specifying a column direction. This causes an identification (specification) of a pixel into which image data is to be written. Specifically, (i) the signals Xm and Yn which are supplied from the address decoder 242 and (ii) a write enable signal (or a read enable signal) are supplied to the AND circuit 33. The AND circuit 33 supplies an output signal to control electrodes of the FETs 31a and 31b. One of conduction electrodes of the FET 31a is connected with a data bus line Dn, and one of conduction electrodes of the FET 31b is connected with a data bus line Dn′ (complementary data signal line of Dn; not illustrated in FIG. 11).

According to the liquid crystal display device 212 of Embodiment 2 thus configured, data is written into only a specified pixel in each frame. This makes it possible to further reduce power consumption as compared with Embodiment 1 in which writing of data into all pixels is carried out in each frame.

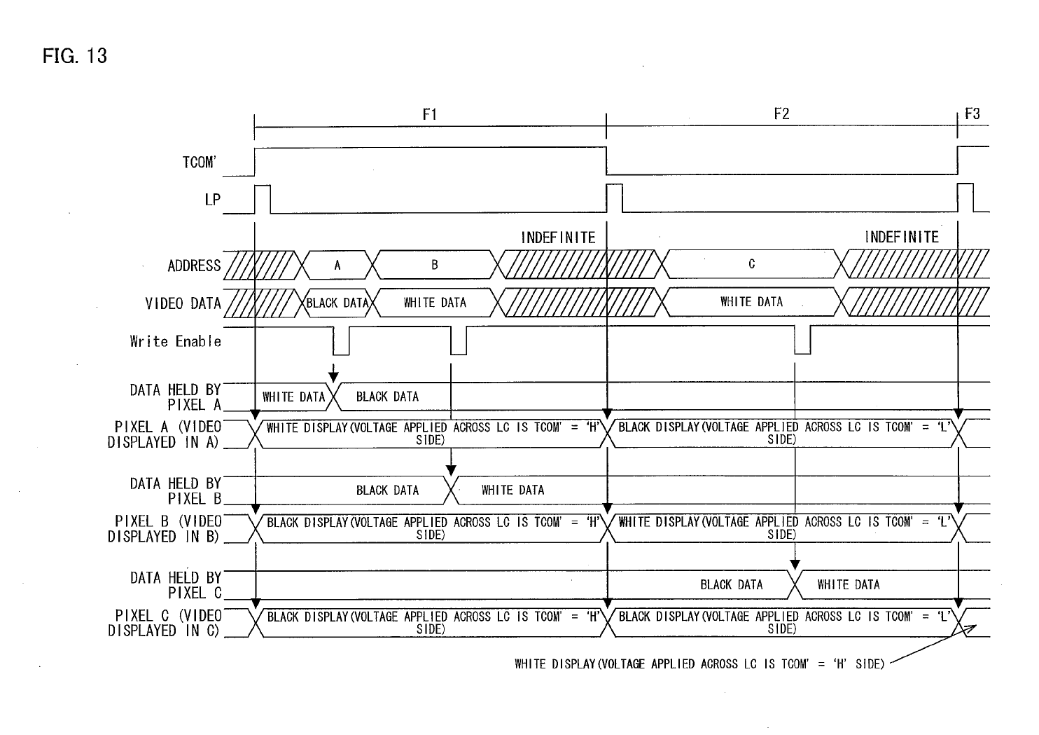

The following describes an example of how the liquid crystal display device 212 having the above configuration operates, with reference to a timing chart shown in FIG. 13.

The CPU controls (i) an address signal (ADDRESS) for identifying (specifying) an address of a pixel, (ii) image data (VIDEO DATA), and (iii) a write enable signal (Write Enable) to be supplied to the liquid crystal display device 212 (see FIG. 11). In sync with the write enable signal becoming a Low level, the image data is supplied to (stored in) the data storing section 302 based on the address signal. Then, a voltage, which varies from display data to display data, is applied across liquid crystal LC of a specified pixel, based on an LP signal generated in sync with a TCOM′ signal. Note that (i) “TCOM′” signal indicates a signal electric potential of a counter electrode and (ii) “LP” indicates a timing signal generated by the LP signal generating circuit. Moreover, “pixel A”, “pixel B”, and “pixel C” indicate (i) signal electric potentials, which are written into the respective pixels A, B, and C, and (ii) display states of the respective pixels A, B, and C. According to the present embodiment, a frame-reversal driving is employed, and an attention is mainly focused on a certain frame (first frame: F1) and a following frame (second frame) out of consecutive frames. Note that, (i) in the first frame (F1), part of image data (VIDEO DATA) is made up of display data for the pixel A (black) and display data for the pixel B (white), and (ii) in the second frame (F2), part of the image data is made up of display data for the pixel C (white).

With regard to the pixel A, black display data is supplied to the data storing section 302 in sync with a falling edge of the write enable signal, in a state where white display data has been written in a frame (a followed frame) which is followed by the first frame (i.e., in a state where white display data is stored in the data storing section 302). The black display data thus supplied to the data storing section 302 is held by the memory section 32 until another display data is supplied to the data storing section 302. The black display data held by the memory section 32 is supplied to the latch circuit 40. In the latch circuit 40, the black display data is latched in sync with a rising edge of the LP signal, and is then supplied to the polarity reversing circuit 50. In the polarity reversing circuit 50, the black display data is latched at timing at which the second frame starts, that is, at timing at which a polarity of the TCOM′ signal is reversed. Then, a voltage polarity of the black display data is reversed in the polarity reversing circuit 50, and is then supplied to the pixel electrode. Accordingly, a voltage, which is an electric potential difference between (i) the black display data whose polarity is reversed and (ii) the TCOM′ signal, is applied across the liquid crystal LC. This causes the pixel A to be switched from the white display to a black display in the second frame.

In the second frame, the pixel A is not selected by the address decoder, and therefore no data writing is carried out. In the second frame, therefore, the black display is continued based on the black display data held in the data storing section 302. That is, in the pixel A, polarity reversals of the black display data are repeated at predetermined time intervals (at time intervals at which a polarity of the TCOM′ signal is reversed) until new writing command is given to the pixel A.

In a case where new black display data which serves as image data is supplied to the data storing section 302 of the pixel A in the first frame, the new black display data is not written into the pixel A at this timing but white display data of the followed frame is still written into the pixel A. The new black display data is written into the pixel A at timing at which a polarity of a subsequent TCOM′ signal is reversed. That is, even if display data is supplied to the liquid crystal display device 212 at any timing during one (1) frame period, then such display data is to be written into a pixel at timing at which a polarity of the TCOM′ signal is reversed. This allows each frame (here, F1 and F2) to have identical write time during which display data is being written into a pixel.

For example, in a case of a normally black display, (i) white display data having a negative polarity is written into a pixel A in a first frame, (ii) black display data having a positive polarity is written into the pixel A in a second frame, and (iii) black display data having a negative polarity is written into the pixel A in a third frame. Note that each of the pieces of display data (white (negative)→black (positive)→black (negative)) is being written into the pixel A for identical period of time.

In the pixel B, concrete operations are identical to those in the pixel A, only except that white display data and black display data are interchanged.

In the pixel C, image data is not switched in the first frame. Specifically, the pixel C is not selected in the first frame and therefore no display data is newly supplied. Then, in the second frame, black display data is switched to white display data. Therefore, black display data, whose polarity is reversed, is written into the pixel C in the second frame.

Specifically, white display data, which is new image data, is supplied to the pixel C in the second frame. Therefore, a display is carried out, until the end of the second frame, based on the black display data which is held by the data storing section 30. Then, in the third frame, the black display is switched to a white display.

For example, in a case of a normally black display, (i) black display data having a positive polarity is written into a pixel C in a first frame, (ii) black display data having a negative polarity is written into the pixel C in a second frame, and (iii) white display data having a positive polarity is written into the pixel C in a third frame. Note that each of the pieces of display data (black (positive)→black (negative)→white (positive)) is being written into the pixel C for identical period of time.

According to the operations, no DC component is applied across the liquid crystal, as with Embodiment 1. It is therefore possible to further improve a display quality, as compared to conventional liquid crystal display devices. Moreover, operations in the pixel C are basically identical to those in the pixel A, except that display data is supplied to the data storing section 30 of the pixel C at a different timing. That is, the time, required for writing image data into a pixel, does not differ from frame to frame. This makes it possible to uniformize a display quality in each pixel.

According to Embodiment 2, timing at which data is written into a pixel can be adjusted based on the LP signal, as with Embodiment 1. This allows the TCOM′ signal and the image data signal to be asynchronous. It is therefore not necessary to prepare a configuration in which a TCOM signal is supplied from the timing generator, unlike the conventional configuration. This allows an outputting circuit (the TCOM′ control circuit of the present embodiment) of the TCOM signal to be provided, separately from the timing generator 25, inside or outside of the liquid crystal display device 21. This makes it possible to (i) simplify the configuration of the timing generator 25 and (ii) cause the timing generator 25 to be commonly used in liquid crystal panels having respective different sizes.

Moreover, according to Embodiment 2, no display data is newly supplied to the data storing section 302 in a frame in which image data is not to be switched. A display is therefore carried out based on display data which is already held by the data storing section 302. That is, the display is carried out based on the display data which is already held by the data storing section 302, while causing a polarity of the display data to be reversed. Since image data can be supplied only to a desired pixel, it is possible to reduce power consumption.

Note that the other configurations of the data storing section 30 and the LP signal generating circuit 60 described in Embodiment 1 are of course applicable to Embodiment 2.

### Embodiment 3

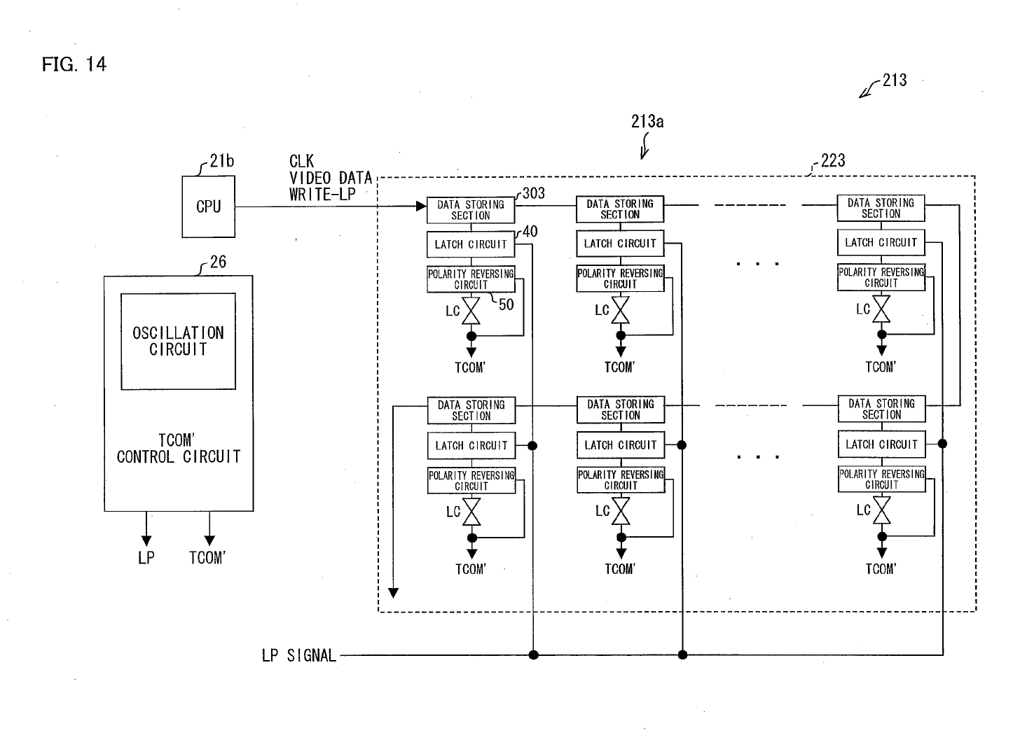

The following description discusses Embodiment 3 of the present invention with reference to FIGS. 14 through 16. The following mainly describes differences between a liquid crystal display device 213 of Embodiment 3 and the liquid crystal display device 21 of Embodiment 1. Note that, for convenience, the same reference numerals are given to members having functions identical to those shown in Embodiment 1, and descriptions as to such members are omitted here. Moreover, the terms, which are defined in Embodiment 1, are used in the same meanings also in the present embodiment, unless otherwise noted.

FIG. 14 illustrates a configuration of the liquid crystal display device (display device) 213 in accordance with Embodiment 3. The liquid crystal display device 213 includes a display panel 213a and a CPU 21b.

The CPU controls a clock signal CLK, an image data (VIDEO DATA), and a write LP signal (WRITE-LP) to be supplied to the display panel 213a.

In an active area 223, pixels, each having colors of R, G, and B, are provided in a matrix manner, and each of the pixels has a pixel memory. The following describes a configuration of pixels PIX provided in the active area 223, with reference to FIG. 14.

Each of the pixels PIX has (i) a data storing section 303, (ii) a latch circuit 40, (iii) a polarity reversing circuit 50, (iv) liquid crystal LC, and (v) a pixel electrode (not illustrated), as with Embodiment 1.

In the liquid crystal display device 213, (i) pixel memories of any adjacent two of the pixels are connected to each other and (ii) a data holding operation in each of the pixels is sequentially shifted in response to the clock signal CLK.

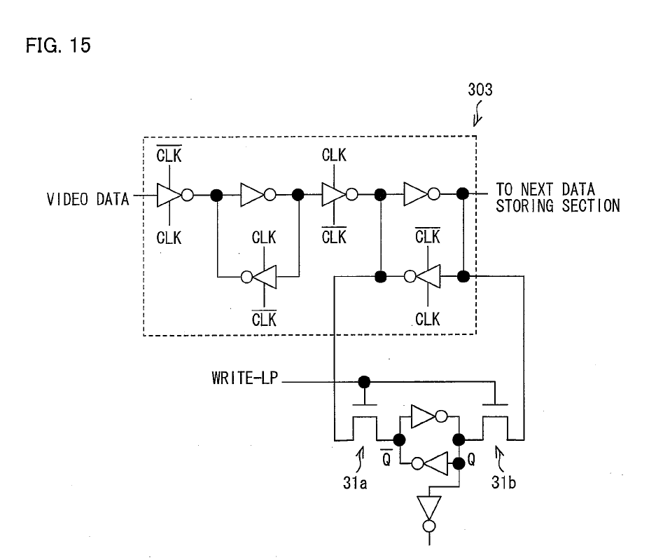

FIG. 15 is a circuit diagram illustrating a configuration of the data storing section 303. Image data (VIDEO DATA) is supplied to one end of the data storing section 303, and the other end is connected with a data storing section of an adjacent pixel (see FIG. 15). The clock signal CLK is supplied to the data storing section 303, and the write LP signal (WRITE-LP) is supplied to control electrodes of respective FETs 31a and 31b. With the circuit configuration, image data is supplied to the data storing section 303 in response to the clock signal CLK, and the image data is stored in the data storing section 303 in response to the write LP signal. Note that, since a part indicated by a dashed line in FIG. 15 serves as a shift register, a supplying operation of the image data is shifted to the adjacent pixel in response to the clock signal CLK.

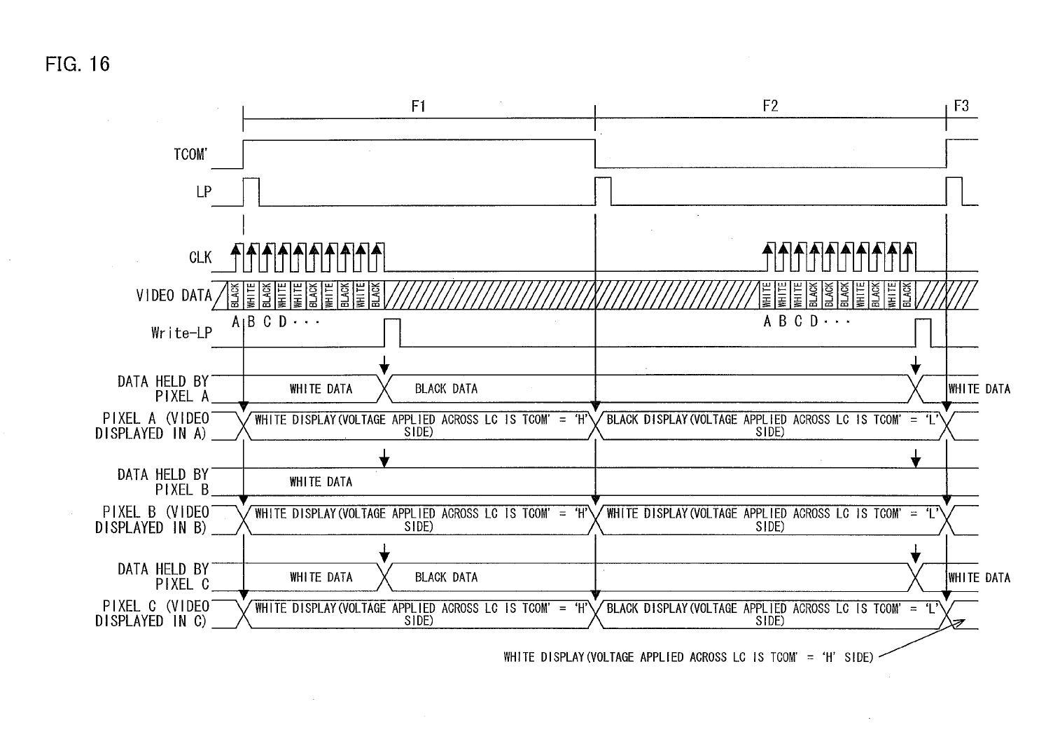

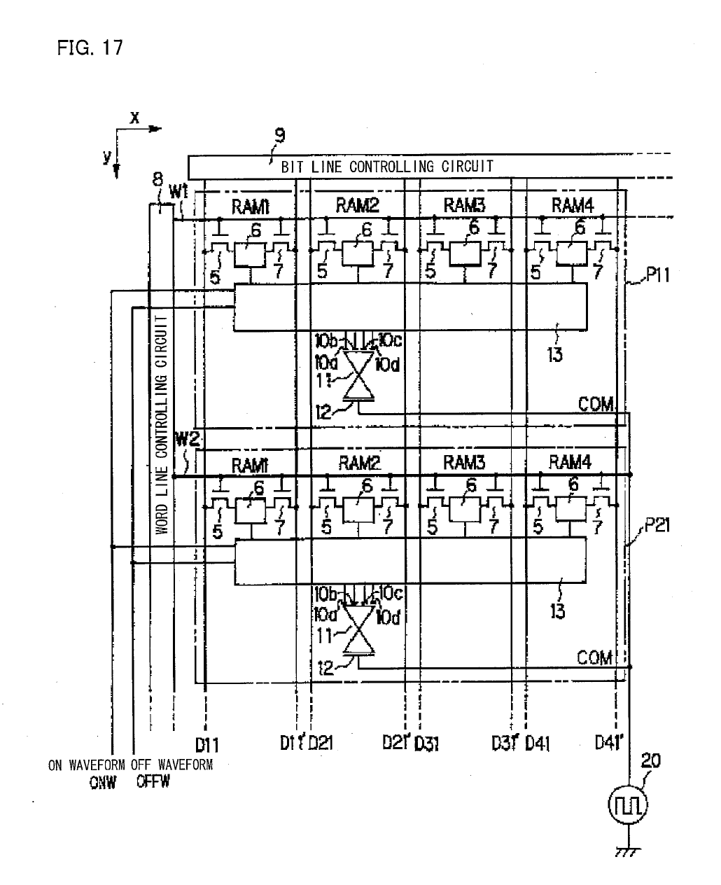

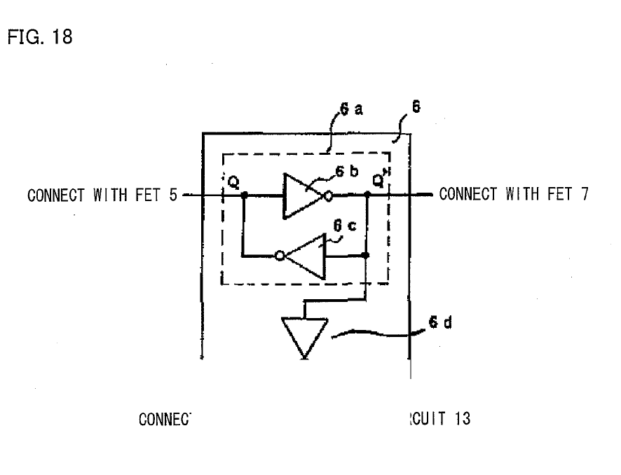

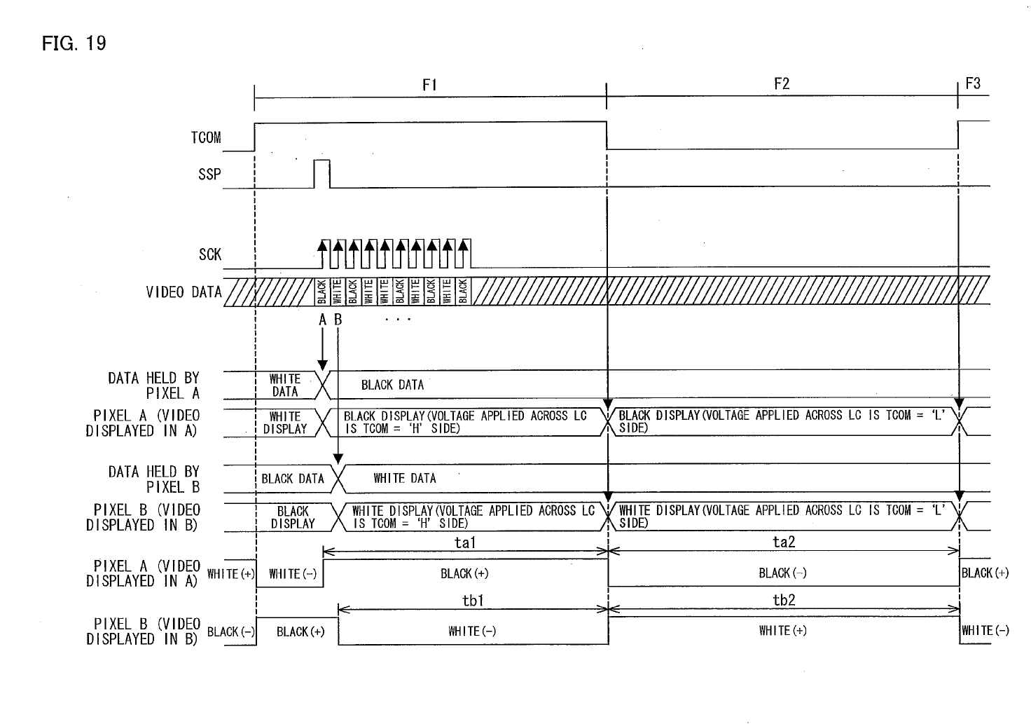

The following describes an example of operations in the liquid crystal display device 213 thus configured, with reference to a timing chart shown in FIG. 16.

The CPU controls the clock signal CLK, the image data (VIDEO DATA), and the write LP signal (WRITE-LP) to be supplied to the liquid crystal display device 213. Then, at timing when the write LP signal becomes a High level, each image data for a corresponding one of the pixels is supplied to (stored in) the data storing sections 303. Specifically, pieces of display data, which constitute respective pieces image data for one (1) frame, are assigned to respective pixels, and then the pieces of display data are concurrently stored in data storing sections of the respective pixels, in sync with a rising edge of the write LP signal. Then, a voltage, which varies depending on the display data, is applied across liquid crystal LC of a corresponding one of the pixels, in response to an LP signal generated in sync with a TCOM′ signal. Note that (i) “TCOM′” signal indicates a signal electric potential of a counter electrode and (ii) “LP” indicates a timing signal generated by the LP signal generating circuit. Moreover, “pixel A”, “pixel B”, and “pixel C” indicate how respective signal electric potentials, which are written into the respective pixels A, B, and C, change.

According to the present embodiment, a frame-reversal driving is employed, and an attention is mainly focused on a certain frame (first frame: F1) and a following frame (second frame) out of consecutive frames. Note that, (i) in the first frame (F1), image data (VIDEO DATA) is made up of display data for the pixel A (black), display data for the pixel B (white), and display data for the pixel C (black), and (ii) in the second frame (F2), the image data is made up of display data for the pixel A (white), display data for the pixel B (white), and display data for the pixel C (white).

In the pixel A, black display data is stored in the data storing section 303 in sync with a rising edge of the write LP signal, in a state where white display data has been written in a followed frame of the first frame (i.e., in a state where white display data is stored in the data storing section 303). In the pixel B, new white display data is stored in the data storing section 303 in sync with a rising edge of the write LP signal, in a state where white display data has been written in the followed frame of the first frame (i.e., in a state where white display data is stored in the data storing section 303). In the pixel C, black display data is stored in the data storing section 303 in sync with a rising edge of the write LP signal, in a state where white display data has been written in the followed frame of the first frame (i.e., in a state where white display data is stored in the data storing section 303).

The pieces of display data are thus concurrently stored in the data storing sections 303 of the respective pixels in response to the write LP signal.

Each piece of the display data, which is stored in a corresponding data storing section 303, is latched by a corresponding latch circuit 40 (see FIG. 14) in sync with a rising edge of the LP signal, and is then supplied to a polarity reversing circuit 50 (see FIG. 14). In the polarity reversing circuit 50, the each piece of the display data is latched at timing at which the second frame starts, that is, at timing at which a polarity of the TCOM′ signal is reversed. Then, a voltage polarity of the each piece of the display data is reversed in the polarity reversing circuit 50, and then the each piece of the display data is supplied to the pixel electrode. Accordingly, a voltage, which is an electric potential difference between (i) the each piece of the display data whose polarity is reversed and (ii) the TCOM′ signal, is applied across the liquid crystal LC.

Specifically, in each of the pixels A and C, black display data, which has been newly supplied to the data storing section 303 in sync with the write LP signal, is held by the memory section 32 until another display data is supplied to the data storing section 303. The black display data held by the memory section 32 is supplied to the latch circuit 40. In the latch circuit 40, the black display data is latched in sync with a rising edge of the LP signal, and is then supplied to the polarity reversing circuit 50. Then, a voltage polarity of the black display data is reversed in the polarity reversing circuit 50, and then the black display data is supplied to the pixel electrode. Accordingly, a voltage, which is an electric potential difference between (i) the black display data whose polarity is reversed and (ii) the TCOM′ signal, is applied across the liquid crystal LC. This causes each of the pixels A and C to be switched from the white display to a black display in the second frame.

Subsequently, in the pixel A, white display data is supplied to the data storing section 303 in sync with a write LP signal, in a state where the black display data has been written in the second frame (i.e., in a state where black display data is stored in the data storing section 303). In the data storing section 303, the white display data is held by the memory section 32 until another display data is supplied to the data storing section 303. The white display data held by the memory section 32 is supplied to the latch circuit 40. In the latch circuit 40, the white display data is latched in sync with a rising edge of the LP signal, and is then supplied to the polarity reversing circuit 50. In the polarity reversing circuit 50, the white display data is latched at timing at which the third frame (F3) starts, that is, at timing at which the polarity of the TCOM′ signal is reversed. Then, a voltage polarity of the white display data is reversed in the polarity reversing circuit 50, and then the white display data is supplied to the pixel electrode. Accordingly, a voltage, which is an electric potential difference between (i) the white display data whose polarity is reversed and (ii) the TCOM′ signal, is applied across the liquid crystal LC. This causes each of the pixels A and C to be switched from the black display to a white display in the third frame.

In a case where new black display data which serves as image data is supplied to the pixels A and C in the first frame, the new black display data is not written into the pixel A at this timing but white display data of the followed frame is still written into the pixel A. The new black display data is written into the pixel A at timing at which a polarity of a subsequent TCOM′ signal is reversed. That is, even if display data is supplied to the liquid crystal display device 213 at any timing during one (1) frame period, then such display data is to be written into a pixel at timing at which a polarity of the TCOM′ signal is reversed. This allows each frame to have identical write time during which display data is being written into a pixel.

For example, in a case of a normally black display, (i) white display data having a negative polarity is written into a pixel A in a first frame, (ii) black display data having a positive polarity is written into the pixel A in a second frame, and (iii) white display data having a negative polarity is written into the pixel A in a third frame. Note that each of the pieces of display data (white (negative)→black (positive)→white (negative)) is being written into the pixel A for identical period of time.

In the pixel B, white display data is supplied, in sync with the write LP signal, to the data storing section 303 so that the white display data is stored in the data storing section 303, in a state where white display data has been written in a frame (a followed frame) which is followed by the first frame (i.e., in a state where white display data is stored in the data storing section 303). Note that, although the white display data is actually supplied to the data storing section 303 (i.e., the white display data is overwritten) in the first frame, the content itself in the data storing section 303 does not change. This is because the display data is identical to that held from the frame followed by the first frame, and therefore the white display data thus supplied to the data storing section 303 is held by the memory section 32 until another display data is supplied to the data storing section 303. The white display data held by the memory section 32 is supplied to the latch circuit 40. In the latch circuit 40, the white display data is latched in sync with a rising edge of the LP signal, and is then supplied to the polarity reversing circuit 50. In the polarity reversing circuit 50, the white display data is latched at timing at which the second frame starts, that is, at timing at which a polarity of the TCOM′ signal is reversed. Then, a voltage polarity of the white display data is reversed in the polarity reversing circuit 50, and then the white display data is supplied to the pixel electrode. Accordingly, a voltage, which is an electric potential difference between (i) the white display data whose polarity is reversed and (ii) the TCOM′ signal, is applied across the liquid crystal LC. This causes the white display to be held by the pixel B in the second frame.

Subsequently, in a state where the white display data has been written into the pixel B in the second frame (i.e., in a state where the white display data is stored in the data storing section 30), another white display data is further supplied to the data storing section 303 in sync with the write LP signal. The white display data thus supplied to the data storing section 303 is held by the memory section 32 until another display data is supplied to the data storing section 303. The white display data held by the memory section 32 is supplied to the latch circuit 40. In the latch circuit 40, the white display data is latched in sync with a rising edge of the LP signal, and is then supplied to the polarity reversing circuit 50. In the polarity reversing circuit 50, the white display data is latched at timing at which the third frame (F3) starts, that is, at timing at which the polarity of the TCOM′ signal is reversed. Then, a voltage polarity of the white display data is reversed in the polarity reversing circuit 50, and then the white display data is supplied to the pixel electrode. Accordingly, a voltage, which is an electric potential difference between (i) the white display data whose polarity is reversed and (ii) the TCOM′ signal, is applied across the liquid crystal LC. This causes the white display to be still held by the pixel B in the third frame.

In a case where new white display data which serves as image data is supplied to the pixel B in the first frame, the new white display data is not written into the pixel B at this timing but white display data of the followed frame is still written into the pixel B. The new white display data is written into the pixel B at timing at which a polarity of a subsequent TCOM′ signal is reversed.

For example, in a case of a normally black display, (i) white display data having a negative polarity is written into a pixel B in a first frame, (ii) white display data having a positive polarity is written into the pixel B in a second frame, and (iii) white display data having a negative polarity is written into the pixel B in a third frame. Note that each of the pieces of display data (white (negative)→white (positive)→white (negative)) is being written into the pixel B for identical period of time.

According to the operations, no DC component is applied across the liquid crystal, as with Embodiment 1. This makes it possible to improve a display quality, as compared to conventional liquid crystal display devices.

According to Embodiment 3, timing of writing data into a pixel can be adjusted based on the LP signal, as with Embodiment 1. This allows the TCOM′ signal and the image data signal to be asynchronous. It is therefore not necessary to prepare a configuration in which a TCOM signal is supplied from the timing generator, unlike the conventional configuration. This allows an outputting circuit (the TCOM′ control circuit of the present embodiment) of the TCOM signal to be provided, separately from the timing generator 25, inside or outside of the liquid crystal display device 21. This makes it possible to (i) simplify the configuration of the timing generator 25 and (ii) cause the timing generator 25 to be commonly used in liquid crystal panels having respective different sizes.

The present invention is not limited to the embodiments, but can be altered by a skilled person in the art within the scope of the claims. An embodiment derived from a proper combination of technical means disclosed in respective different embodiments is also encompassed in the technical scope of the present invention. The present invention is applicable to, for example, an EL display device.

### INDUSTRIAL APPLICABILITY

The present invention is suitably applicable, particularly, to a portable terminal such as a mobile phone.

### REFERENCE SIGNS LIST

21, 212, and 213: Liquid crystal display device (display device)
21a, 212a, and 213a: Display panel
21b: CPU
22, 222, and 223: Active area
23: Source driver (data signal line driving circuit, display driver)
232: Data driver (display driver)
24: Gate driver (scanning signal line driving circuit, display driver)
242: Address decoder (display driver)
25: Timing generator (display driver)
26: TCOM′ control circuit
30, 302, 303: Data storing section (data storing means)
31a, 31b: Field-effect transistor (FET)
32: Memory
32a and 32b: Inverter
40: Latch circuit
50: Polarity reversing circuit (polarity controlling means)
40a through 40c: Inverter
TCOM′ signal: Counter electrode voltage
S1 and S2: Source line (data signal line)
G1 and G2: Gate line (scanning signal line)
D1 and D2: Data bus line
X1 and X2: Address signal line in row direction
Y1 and Y2: Address signal line in column direction

1. An active matrix display device comprising:
a plurality of pixels; and
a display driver which supplies image data, which has been externally supplied, to the plurality of pixels,
each of the plurality of pixels having:
a data storing means for storing the image data supplied from the display driver;
a latch circuit which latches, at a predetermined timing, the image data which is stored in the data storing means; and
a polarity controlling means for controlling a polarity of the image data which is latched by the latch circuit,
the image data, whose polarity is controlled by the polarity controlling means, being written into the each of the plurality of pixels.

2. The display device as set forth in claim 1, wherein:
the latch circuit latches the image data, which is stored in the data storing means, in sync with a polarity reversal of a voltage of a counter electrode.

3. The display device as set forth in claim 1, wherein:
the polarity controlling means reverses, in each frame, the polarity of the image data which is latched by the latch circuit.

4. The display device as set forth in claim 1, wherein:
the display driver includes
a timing generator to which image data and a timing signal are externally supplied,
a data signal line driving circuit which drives a plurality of data signal lines in response to outputs of the timing generator, and
a scanning signal line driving circuit which sequentially drives a plurality of scanning signal lines in response to outputs of the timing generator; and
the data storing means is provided, at an intersection of a corresponding one of the plurality of data signal lines and a corresponding one of the plurality of scanning signal lines, so as to be connected with the corresponding one of the plurality of data signal lines and the corresponding one of the plurality of scanning signal lines.

5. The display device as set forth in claim 1, wherein the display driver includes:
an address decoder which specifies a pixel to which image data is supplied, and
a data driver which supplies the image data to the pixel,
the plurality of pixels being provided at respective intersections of a plurality of address signal lines which extend in a row direction and a column direction and are driven by the address decoder, and
the data storing means being connected with, at a corresponding one of the intersections, a corresponding one of the plurality of address signal lines and a corresponding one of a plurality of data signal lines which are driven by the data driver.

6. The display device as set forth in claim 1, wherein:
the display driver and a display panel are provided monolithically.

7. The display device as set forth in claim 1, being a liquid crystal display device.

8. A portable terminal in which a display device recited in claim 1 is provided as a display.

9. The display device as set forth in claim 2, wherein:
the display driver includes
a timing generator to which image data and a timing signal are externally supplied,
a data signal line driving circuit which drives a plurality of data signal lines in response to outputs of the timing generator, and
a scanning signal line driving circuit which sequentially drives a plurality of scanning signal lines in response to outputs of the timing generator; and
the data storing means is provided, at an intersection of a corresponding one of the plurality of data signal lines and a corresponding one of the plurality of scanning signal lines, so as to be connected with the corresponding one of the plurality of data signal lines and the corresponding one of the plurality of scanning signal lines.

10. The display device as set forth in claim 3, wherein:
the display driver includes
a timing generator to which image data and a timing signal are externally supplied,
a data signal line driving circuit which drives a plurality of data signal lines in response to outputs of the timing generator, and
a scanning signal line driving circuit which sequentially drives a plurality of scanning signal lines in response to outputs of the timing generator; and
the data storing means is provided, at an intersection of a corresponding one of the plurality of data signal lines and a corresponding one of the plurality of scanning signal lines, so as to be connected with the corresponding one of the plurality of data signal lines and the corresponding one of the plurality of scanning signal lines.

11. The display device as set forth in claim 2, wherein the display driver includes:
an address decoder which specifies a pixel to which image data is supplied, and
a data driver which supplies the image data to the pixel,
the plurality of pixels being provided at respective intersections of a plurality of address signal lines which extend in a row direction and a column direction and are driven by the address decoder, and
the data storing means being connected with, at a corresponding one of the intersections, a corresponding one of the plurality of address signal lines and a corresponding one of a plurality of data signal lines which are driven by the data driver.

12. The display device as set forth in claim 3, wherein the display driver includes:
an address decoder which specifies a pixel to which image data is supplied, and
a data driver which supplies the image data to the pixel,
the plurality of pixels being provided at respective intersections of a plurality of address signal lines which extend in a row direction and a column direction and are driven by the address decoder, and
the data storing means being connected with, at a corresponding one of the intersections, a corresponding one of the plurality of address signal lines and a corresponding one of a plurality of data signal lines which are driven by the data driver.

13. The display device as set forth in claim 2, wherein:
the display driver and a display panel are provided monolithically.

14. The display device as set forth in claim 3, wherein:
the display driver and a display panel are provided monolithically.

15. The display device as set forth in claim 4, wherein:
the display driver and a display panel are provided monolithically.

16. The display device as set forth in claim 5, wherein:
the display driver and a display panel are provided monolithically.

17. The display device as set forth in claim 2, being a liquid crystal display device.

18. The display device as set forth in claim 3, being a liquid crystal display device.

19. The display device as set forth in claim 4, being a liquid crystal display device.

20. The display device as set forth in claim 5, being a liquid crystal display device.
